(19) United States
(12) Patent Application Publication
(10) Pub. No.: US 2014/0267387 A1
(43) Pub. Date: Sep. 18, 2014

(54) AREA SELECTION PROCESSING APPARATUS AND METHOD FOR MEDIA EDITING AND COMPUTER READABLE RECORDING MEDIUM

(71) Applicant: Samsung Electronics Co., Ltd., Suwon-si (KR)

(72) Inventors: Soo-Jung BAE, Seoul (KR); Jong-Hyun HAN, Seoul (KR)

(73) Assignee: Samsung Electronics Co., Ltd., Suwon-si (KR)

(21) Appl. No.: 14/196,371

(22) Filed: Mar. 4, 2014

(30) Foreign Application Priority Data
Mar. 14, 2013 (JP) 10-2013-0027561

(51) Int. Cl. G06T 11/60

(52) U.S. Cl. CPC G06T 11/60
USPC 345/625; 345/619

(57) ABSTRACT

An area selection processing apparatus for displaying a selected area and an unselected area of an image are provided. The apparatus includes a first image buffer that temporarily stores a target image currently being displayed, an image convertor that converts the target image through an image conversion method, a second image buffer that temporarily stores the target image converted through the image convertor, an area selection determining unit that determines whether an area is selected for the target image, and an area selection processor that processes the target images such that the corresponding selected area of the target image stored in the first image buffer is displayed for the selected area, and the corresponding unselected area of the converted image stored in the second image buffer is displayed for the unselected area, when the area selection determining unit determines that the specific area is selected.

### CROSS-REFERENCE TO RELATED APPLICATION(S)

This application claims the benefit under 35 U.S.C. §119(a) of a Korean patent application filed on Mar. 14, 2013 in the Korean Intellectual Property Office and assigned Serial No. 10-2013-0027561, the entire disclosure of which is hereby incorporated by reference.

### TECHNICAL FIELD

The present disclosure relates to an area selection processing apparatus for media editing. More particularly, the present disclosure relates to an apparatus and a method for processing an area selection for media editing which display a selected area visually differentiated from an unselected area during editing of the media, and a computer readable medium.

### BACKGROUND

In recent years, as a performance of personal computers has advanced, and various application programs have been developed, users are able to edit images simply by using the personal computers. In addition, as a performance of smart phones similarly continues to advance, the smart phones also provide functions through which users can simply edit images photographed through the smart phones.

When editing media, such as an image or a video, a case may occur in which a user desires to select a specific area of the entire image. However, according to the related art, since a selected area is differentiated only through a boundary line when the specific area is selected, in a case where a color of the image is similar to that of the boundary line, the selected area is not clearly differentiated from an unselected area.

FIG. 1 shows a method of differentiating a selected area according to the related art.

Referring to FIG. 1, when a specific area is selected in an editing target image 100, a selected area 110 may be differentiated thorough a boundary line 111, and in a case where a color of the boundary line 111 is similar to that of an area adjacent to the boundary line 111 in the target image, the boundary line 111 is not clearly distinguished.

FIG. 2 shows a method of displaying an insert image according to the related art.

Referring to FIG. 2, when a target image 200 occupies one area of the whole display area, an insert image 210 (e.g., an image clip, or an icon) may depart from an area of the target image 200. In this case, since a portion of the insert image 210 may be cut away, it is difficult for users to perform desired editing and to effectively adjust a location of the insert image 210.

Accordingly, there is a need for an improved apparatus and method for selecting an area for media editing in which, when a specific area is selected in a selection mode, an unselected area of the image is converted, whereby the selected area and the unselected area are clearly differentiated from each other.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus and a method for processing area selection for media editing in which during editing of the media, when a specific area is selected in a state where a selection mode is entered, an unselected area is image converted, whereby the selected area and the unselected area are clearly differentiated from each other, and a computer readable medium.

Another aspect of the present disclosure is to provide an apparatus and a method for processing area selection for media editing in which, when an insert image is arranged in a target image, in a case where at least one area of the insert image departs from the target image, the corresponding area which departs from the target image is image filtered, whereby users can easily perform the image editing, and a computer readable medium.

The above-described aspects of the present disclosure and special effects of the present disclosure which will be described can be achieved by configurations which will be described below.

In accordance with an aspect of the present disclosure, an area selection processing apparatus for media editing which displays a selected area and an unselected area of an image is provided. The area selection processing apparatus for media editing includes a first image buffer configured to temporarily store a target image currently being displayed, an image convertor configured to convert the target image through an image conversion method, a second image buffer configured to temporarily store the target image converted through the image convertor, an area selection determining unit configured to determine whether an area is selected for the target image, and an area selection processor configured to process the target images such that the corresponding selected area of the target image stored in the first image buffer is displayed for the selected area, and the corresponding unselected area of the converted image stored in the second image buffer is displayed for the unselected area, when the area selection determining unit determines that the specific area is selected.

The image convertor may perform image filtering of the target image.

The image filtering may include any one selected from Blur, Embossing, Jitter, Sepia, Gray scale, and Invert.

The area selection processing unit may superpose the target image stored in the first image buffer on the converted target image stored in the second image buffer, and when the area selection determining unit determines that the specific area is selected, remove the unselected area among the whole area of the target image such that the corresponding area of the converted target image is displayed in the unselected area.

The area selection processing unit may superpose the converted target image stored in the second image buffer on the target image stored in the first image buffer, and when the area selection determining unit determines that the specific area is selected, remove an area corresponding to the selected area among the whole area of the converted target image such that the corresponding area of the converted target image is displayed in the unselected area.

In accordance with another aspect of the present disclosure, an image display processing apparatus for displaying an insert image added to a target image is provided. The image display processing apparatus includes a first image buffer configured to temporarily store the added insert image, an image convertor configured to convert the insert image through an image conversion method, a second image buffer configured to temporarily store the insert image converted through the image convertor, an insert image area determining unit configured to determine whether at least one area of the insert image departs from the whole area of the target image according to a location change of the insert image, and an insert image display processor configured to process the insert images such that the corresponding area of the insert image stored in the first image buffer is displayed for an area included in the target image among the whole area of the insert image, and the corresponding area of the converted insert image stored in the second image buffer is displayed for an area departing from the target image among the whole area of the insert image, when it is determined that at least one area of the whole area of the insert image departs from an area of the original target image according to the determination result of the insert image area determining unit.

In accordance with another aspect of the present disclosure, an area selection processing method for media editing which displays a selected area and an unselected area of an image is provided. The area selection processing method for media editing includes temporarily storing a target image currently being displayed in a first image buffer, converting the target image through an image conversion method, temporarily storing the converted target image in a second image buffer, determining whether an area is selected for the target image, and processing the target image such that the corresponding selected area of the target image stored in the first image buffer is displayed for the selected area, and the corresponding unselected area of the converted image stored in the second image buffer is displayed for the unselected area, when it is determined that the specific area is selected.

In accordance with another aspect of the present disclosure, an image display processing method for displaying an insert image added to a target image is provided. The image display processing method includes temporarily storing the added insert image in a first image buffer, converting the insert image through an image conversion method, temporarily storing the insert image converted through the image convertor in a second image buffer, determining whether at least one area of the insert image departs from the whole area of the target image according to a location change of the insert image, and processing the insert image such that the corresponding area of the insert image stored in the first image buffer is displayed for an area included in the target image among the whole area of the insert image, and the corresponding area of the converted insert image stored in the second image buffer is displayed for an area departing from the target image among the whole area of the insert image, when it is determined that at least one area of the whole area of the insert image departs from an area of the original target image according to the determination result.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other aspects, features, and advantages of certain embodiments of the present disclosure will be more apparent from the following description taken in conjunction with the accompanying drawings, in which:

FIG. 1 shows a method of differentiating a selected area according to the related art;

FIG. 2 shows a method of displaying an insert image according to the related art;

FIG. 3 is a diagram showing a concept of differentiating between a selected area and an unselected area according to a first embodiment of the present disclosure;

FIG. 4 is a block diagram showing a structure of an area selection processing apparatus for media editing according to the first embodiment of the present disclosure;

FIG. 5 is a flowchart showing a procedure of processing area selection for media editing according to the first embodiment of the present disclosure;

FIG. 6 is a diagram showing a method for displaying an insert image according to a second embodiment of the present disclosure;

FIG. 7 is a block diagram showing a structure of an area selection processing apparatus for media editing according to the second embodiment of the present disclosure;

FIG. 8 is a flowchart showing a procedure of processing area selection for media editing according to the second embodiment of the present disclosure;

FIG. 9 shows an area selection result according to the first embodiment of the present disclosure;

FIG. 10 shows an insert image display result according to the second embodiment of the present disclosure; and

FIG. 11 shows a result where the present disclosure is applied to a moving image trim function according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The following description discloses an apparatus and a method for processing area selection for media editing which allow a selected area and an unselected area to be displayed in a state of being visually differentiated from each other during editing of the media such as images or videos.

To this end, in the present disclosure, when a specific area is selected in an editing target image, an area which is not selected (e.g., an area except for the selected area in the whole area of the target image) (hereinafter, referred to as ‘an unselected area’) is image converted and displayed, whereby a differentiation between the selected area and the unselected area can be clearly made. Meanwhile, various image filtering techniques are applied to the present disclosure as an image conversion for the unselected area. In this way, the differentiation between the areas can be made clear irrespective of colors or types of target image.

Hereinafter, various embodiments of the present disclosure will be described with reference to the accompanying drawings in order that those skilled in the art to which the present disclosure pertains may readily carry out the present disclosure.

First, an apparatus and a method according to a first embodiment of the present disclosure will be described with reference to FIGS. 3 through 5, and then an apparatus and a method according to a second embodiment of the present disclosure will be described with reference to FIGS. 6 through 8.

### First Embodiment

### Differentiation Between a Selected Area and an Unselected Area

FIG. 3 is a diagram showing a concept of differentiating between a selected area and an unselected area according to a first embodiment of the present disclosure.

Referring to FIG. 3, according to the first embodiment of the present disclosure, the whole area of an original target image 300 is image converted, and thus a converted image 320 is generated. At this time, when a specific area of the original target image 300 is selected through an input means (e.g., a hand or a pen, in a case of a terminal provided with a touch screen), the corresponding area of the original target image 300 is displayed for a selected area 310, and the corresponding area of the converted image 320 is displayed for the remaining area (e.g., an unselected area 320) except for the selected area 310.

During selection of the area, a method in which the unselected area 320 is displayed through the converted image as described above may be variously realized.

For example, when a selection mode is entered in an image editing program, the original target image 300 is image converted (e.g., image filtered), and the converted image 320 (e.g., the filtered image) is temporarily stored in a buffer. At this time, the original target image 300 is superposed on the converted image 320 in a layer form. Accordingly, before a specific area is selected, only the original target image 300 which corresponds to an upper positioned layer is displayed. When a specific area is selected by a user in the original target image 300, the unselected area 320 is removed in the upper positioned original target image 300 with the corresponding selected area 310 remaining. Thus, the corresponding area of the original target image 300 is displayed in the selected area 310, and since the original target image 300 which corresponds to the upper positioned layer is removed, the corresponding area of the converted image 320 which corresponds to a lower positioned layer is displayed in the remaining unselected area 320. In this way, during the selection of the specific area, the filtered image is displayed in the unselected area 320, whereby the user can clearly differentiate between the selected area 310 and the unselected area 320.

On the other hand, in a method according to another embodiment of the present disclosure, the converted image 320 is superposed on the original target image 300, whereby displaying an unselected area 320 through the converted image may also be realized. That is, the converted image 320 is superposed and displayed on the original target image 300, and when a specific area is selected, the selected area 310 of the converted image 320 which corresponds to an upper positioned layer is removed. Thus, the original target image 300 which corresponds to a lower positioned layer is displayed in the selected area 310, and the converted image 320 which corresponds to the upper positioned layer is displayed in the unselected area 320.

Hereinafter, an apparatus and a method according to the first embodiment of the present disclosure will be described with reference to FIGS. 4 and 5.

FIG. 4 is a block diagram showing a structure of an area selection processing apparatus for media editing according to a first embodiment of the present disclosure.

Referring to FIG. 4, the apparatus according to the first embodiment of the present disclosure may include a first image buffer 410, an image convertor 420, a second image buffer 430, an area selection determining unit 440, and an area selection processor 450.

During editing of an image in an image editing program, when an area selection mode is entered, an editing target image is temporarily stored in the first image buffer 410. Moreover, according to the first embodiment of the present disclosure, the editing target image is image converted in the image convertor 420 to be temporarily stored in the second image buffer 430.

The image convertor 420 processes the editing target image through various image converting methods, and filters the image according to the first embodiment of the present disclosure. Various methods may be applied to the image filtering. For example, image filtering methods such as Blur, Embossing, Jitter, Sepia, Gray scale, Invert, and the like may be applied. Of course, the present disclosure is not limited thereto.

The area selection determining unit 440 determines area selection according to an input from a user. The method of the area selection may be variously realized according to a type of terminal and a type of input means. For example, when a touch screen is installed in the terminal as described above, a specific area may be selected through a touch by a hand or a pen.

The area selection processor 450 is provided with area information on the selected area according to the area selection determination of the area selection determining unit 440, and processes the images such that the selected area is differentiated from an unselected area. That is, according to the first embodiment of the present disclosure, the area selection processor 450 processes the images such that the corresponding area of an original target image stored in the first image buffer 410 is displayed for the selected area, and the corresponding area of the converted image stored in the second image buffer 430 is displayed for the unselected area. In this way, when the specific area is selected, the selected area and the unselected area may be clearly differentiated from each other when displayed.

At this time, the method, in which the area selection processor 450 processes the images such that the selected area and the unselected area are differentiated from each other when displayed, may be variously realized, and as described above, as the editing target image stored in the first image buffer 410, and the converted image stored in the second image buffer 430 overlap each other, and the selected area or the unselected area is removed, may be realized.

Although the elements of the apparatus are separately shown in the drawing in order to illustrate that they may be functionally and logically separated, it does not necessarily mean that the elements are physically separated, or are realized through separate codes.

In the present description, each function unit (or each module) may refer to a functional and structural combination between hardware for performing the spirit of the present disclosure and software for driving the hardware. For example, it can be easily deduced by one of average skill in the art to which the present disclosure pertains that each function unit may refer to a logical unit of a code and a hardware resource for executing the code, and may not necessarily refer to a physically connected code, or one type of hardware.

FIG. 5 is a flowchart showing a procedure of processing area selection for media editing according to the first embodiment of the present disclosure.

Referring to FIG. 5, when an area selection mode is entered during editing of an image in an image editing program, an editing target image, which is currently being displayed on a screen, is temporarily stored in a memory, for example the first image buffer 410, at operation S501. Thereafter, the target image which is currently being displayed is image converted to be temporarily stored in a separate space (e.g., the second image buffer 430) at operation S502.

When it is determined that a specific area is selected through an input by a user in the target image at operation S503, the corresponding area of the converted target image is displayed for an area which is not selected (e.g., an unselected area) at operation 5504. In this way, during the selection of the area, the selected area and the unselected area may be clearly distinguished from each other.

The above-described area selection processing method for media editing according to the various embodiments of the present disclosure may be realized in the form of a program command capable of being performed through various computer means to be recorded in a computer readable medium. The computer readable medium may include any one or all combinations of a program command, a data file, and a data structure. The program command recorded in the medium may correspond to what is specially designed and configured for the present disclosure, or what is well known to the those skilled in the computer software fields to be used. The computer readable medium includes magnetic media such as a hard disk, a floppy disk, and a magnetic tape, optical media such as a CD-ROM, and a DVD, magneto-optical media such as a floptical disk, and a hardware device such as a ROM, a RAM, and a flash memory, specially configured to store and perform the program command. The program command includes a high level language code capable of being executed in computers by using an interpreter as well as a machine language code produced by a compiler. The above-described hardware device may be configured to operate as one or more software modules in order to perform an operation of the present disclosure, and vice versa.

### Second Embodiment

### Display of an Insert Image Departing from an Area

FIG. 6 is a diagram showing a method for displaying an insert image according to a second embodiment of the present disclosure.

Referring to FIG. 6, when an editing target image 610 occupies one area of the whole display area 600, an insert image 620 (e.g., a sticker image) may depart from an area of the editing target image 610.

That is, as shown on a right side of FIG. 6, when the insert image 620 is moved to a lower right side of the editing target image 610, a situation in which a lower area of the insert image 620 departs from the editing target image 610 may Occur.

At this time, according to the second embodiment of the present disclosure, an original insert image may be displayed as it is in an area 620a (e.g., an upper area of the insert image 620 in FIG. 6) included in the editing target image 610 among the whole area of the insert image 620, and a converted image (e.g., a filtered image) may be displayed in an area 620b (e.g., a lower area of the insert image 620 in FIG. 6) departing from the editing target image 610 among the whole area of the insert image 620. In this way, a determination may be clearly made as to whether the insert image 620 departs from the area of the editing target image 610.

Hereinafter, an apparatus and a method according to the second embodiment of the present disclosure will be described with reference to FIGS. 7 and 8.

FIG. 7 is a block diagram showing a structure of an area selection processing apparatus for media editing according to the second embodiment of the present disclosure.

Referring to FIG. 7, the apparatus according to the second embodiment of the present disclosure may include a first image buffer 710, an image convertor 720, a second image buffer 730, an insert image area determining unit 740, and an insert image display processor 750.

During editing of an image in an image editing program, when an insert image is selected and added to an original target image, the added insert image is temporarily stored in the first image buffer 710. Moreover, according to the second embodiment of the present disclosure, the insert image is image converted in the image convertor 720 to be temporarily stored in the second image buffer 730.

At this time, the image convertor 720 processes the insert image through various image converting methods, and filters the image according to the second embodiment of the present disclosure. Various methods may be applied to the image filtering. For example, image filtering methods such as Blur, Embossing, Jitter, Sepia, Gray scale, and Invert may be applied, but the present disclosure is not limited thereto.

The insert image area determining unit 740 determines whether the insert image departs from an area of the original target image according to a location change of the insert image by a user.

When at least one area of the whole area of the insert image departs from the area of the original target image according to the determination result of the insert image area determining unit 740, the insert image display processor 750 processes the images such that the filtered image is displayed in the departing area according to the second embodiment of the present disclosure.

That is, the corresponding area of the original insert image stored in the first image buffer 710 is displayed for an area included in the area of the original target image among the whole area of the insert image, and the corresponding area of the converted insert image stored in the second image buffer 730 is displayed for an area departing from the area of the original target image among the whole area of the insert image. In this way, when the insert image departs from the area of an editing target image, the user may clearly recognize that.

At this time, the method in which the insert image display processor 750 differentiates and displays the images for areas may be variously realized, and as described above in the first embodiment, as the original insert image stored in the first image buffer 710, and the converted image stored in the second image buffer 730 overlap each other, and each area is removed, the method may also be realized.

FIG. 8 is a flowchart showing a procedure of processing area selection for media editing according to a second embodiment of the present disclosure.

Referring to FIG. 8, first, during editing of an image in an image editing program, when an insert image is selected and added to an original target image, the added insert image is temporarily stored in a memory, such as the first image buffer 710 at operation S801. Thereafter, the insert image currently being displayed is image converted to be stored in a separate space (e.g., the second image buffer 730) at operation S802.

At operation S803, a determination is made as to whether the insert image departs from the whole area of the editing target image through a location change of the insert image by the user, and when it is determined that at least one area of the insert image departs from the whole area of the target image at operation S804, the corresponding area of the converted insert image is displayed for the departing area of the insert image at operation S805. In this way, when the insert image departs from the area of the editing target image, the user may clearly recognize that.

FIG. 9 shows an area selection result which is processed according to the first embodiment of the present disclosure.

Referring to FIG. 9, during editing of an image, when a user selects a specific area in an area selection mode, an original image is displayed as it is in a selected area 910 of the whole editing target image 900, and a converted (e.g., filtered) image is displayed in an unselected area 920. Accordingly, even when a boundary line 911 between the selected area 910 and the unselected area 920 is not clearly distinguished, the selected area 910 may be clearly differentiated.

FIG. 10 shows an insert image display result which is processed according to the second embodiment of the present disclosure.

Referring to FIG. 10, when an insert image 1010 is added to an original target image 1000 and is moved, the insert image 1010 may depart from the whole area of the target image 1000 as shown on a right side of FIG. 10. At this time, according to the second embodiment of the present disclosure, as the corresponding area of the original insert image is identically displayed in an area 1010a, which does not depart from the target image 1000, among the whole area of the insert image 1010, and the converted image (e.g., a filtered image) is displayed in an area 1010b which departs from the target image 1000, a determination can be clearly made as to whether the insert image departs from the target image.

FIG. 11 shows a result where the present disclosure is applied to a moving image trim function.

Referring to FIG. 11, during editing of the moving image 1100, an area 1110 trimmed by a user's touch is selected and displayed through a filtered image (e.g., a gray filtered image) as in the above-described first embodiment of the present disclosure, whereby editing of the moving image can be easily achieved.

As described above, according to the present disclosure, during editing of the media, when the specific area is selected in the state where the selection mode is entered, the unselected area is image filtered to be displayed, thereby being clearly differentiated from the selected area, which enables the user to easily achieve the image editing.

Further, according to the present disclosure, when the insert image is arranged in the target image, in the case where at least one area of the insert image departs from the target image, the corresponding area which departs from the target image is image filtered to be displayed so that the determination can be clearly made as to whether the insert image departs from the target image, whereby the user can easily perform the image editing.

That is, the selected area is visually differentiated from the unnecessary area through filtering (e.g., gray filtering) for the unnecessary area (the unselected area, or the unedited area), whereby intuitiveness can be enhanced.

In addition, the present disclosure is widely applied to media editing applications (e.g., a gallery, an image editor, a memo application, a video player, and a video editor) as well as a wallpaper set-up, thereby enabling the editing applications to be easily used.

Information for performing an area selection processing for the media editing may be stored in a server computer readable medium. Such a medium as described above includes all types of recording medium in which programs and data are stored to be readable through computer systems. As an example of the recording medium, a Read Only Memory (ROM), a Random Access Memory (RAM), a Compact Disk (CD), a Digital Video Disk (DVD)-ROM, a magnetic tape, a floppy disk, and an optical data storage device are considered. Furthermore, the recording media may be distributed in computer systems connected as a network, and computer readable codes may be stored and executed in a distributed mode in the recording media.

Although the present disclosure has been described using specific examples including detailed elements, limited embodiments, and the drawings, it is to be understood that they are provided merely to help in an overall comprehension of the present disclosure, and the present disclosure is not limited to the above-described various embodiments. It is obvious to those skilled in the art to which the present disclosure pertains that various changes and modifications can be made from such descriptions as described above.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An area selection processing apparatus for media editing which displays a selected area and an unselected area of an image, the area selection processing apparatus comprising:
a first image buffer configured to temporarily store a target image currently being displayed;
an image convertor configured to convert the target image through an image conversion method;
a second image buffer configured to temporarily store the target image converted through the image convertor;
an area selection determining unit configured to determine whether an area is selected for the target image; and
an area selection processor configured to process the target images such that the corresponding selected area of the target image stored in the first image buffer is displayed for the selected area, and the corresponding unselected area of the converted image stored in the second image buffer is displayed for the unselected area, when the area selection determining unit determines that the specific area is selected.

2. The area selection processing apparatus of claim 1, wherein the image convertor is configured to perform image filtering of the target image.

3. The area selection processing apparatus of claim 2, wherein the image filtering comprises any one selected from Blur, Embossing, Jitter, Sepia, Gray scale, and Invert.

4. The area selection processing apparatus of claim 1, wherein the area selection processing unit is configured to superpose the target image stored in the first image buffer on the converted target image stored in the second image buffer, and, when the area selection determining unit determines that the specific area is selected, is configured to remove the unselected area among the whole area of the target image such that the corresponding area of the converted target image is displayed in the unselected area.

5. The area selection processing apparatus of claim 1, wherein the area selection processing unit is configured to superpose the converted target image stored in the second image buffer on the target image stored in the first image buffer, and, when the area selection determining unit determines that the specific area is selected, is configured to remove an area corresponding to the selected area among the whole area of the converted target image such that the corresponding area of the converted target image is displayed in the unselected area.

6. An image display processing apparatus for displaying an insert image added to a target image, the image display processing apparatus comprising:
a first image buffer configured to temporarily store the added insert image;
an image convertor configured to convert the insert image through an image conversion method;
a second image buffer configured to temporarily store the insert image converted through the image convertor;
an insert image area determining unit configured to determine whether at least one area of the insert image departs from the whole area of the target image according to a location change of the insert image; and
an insert image display processor configured to process the insert images such that the corresponding area of the insert image stored in the first image buffer is displayed for an area included in the target image among the whole area of the insert image, and the corresponding area of the converted insert image stored in the second image buffer is displayed for an area departing from the target image among the whole area of the insert image, when it is determined that at least one area of the whole area of the insert image departs from an area of the original target image according to the determination result of the insert image area determining unit.

7. The image display processing apparatus of claim 6, wherein the image convertor is configured to perform image filtering of the target image.

8. The image display processing apparatus of claim 7, wherein the image filtering comprises any one selected from Blur, Embossing, Jitter, Sepia, Gray scale, and Invert.

9. The image display processing apparatus of claim 6, wherein the insert image display processor is configured to superpose the insert image stored in the first image buffer on the converted insert image stored in the second image buffer, and, when the insert image area determining unit determines that at least one area of the whole area of the insert image departs from an area of the original target image, is configured to remove the corresponding area of the insert image for the area departing from the target image among the whole area of the insert image such that the corresponding area of the converted insert image is displayed in the departing area.

10. The image display processing apparatus of claim 6, wherein the insert image display processor is configured to superpose the converted insert image stored in the second image buffer on the insert image stored in the first image buffer, and, when the insert image area determining unit determines that at least one area of the whole area of the insert image departs from an area of the original target image, is configured to remove the corresponding area of the converted insert image for the area included in the target image among the whole area of the converted insert image such that the corresponding area of the converted insert image is displayed in the departing area.

11. An area selection processing method for media editing which displays a selected area and an unselected area of an image, the area selection processing method for media editing comprising:
temporarily storing a target image currently being displayed in a first image buffer;
converting the target image through an image conversion method;
temporarily storing the converted target image in a second image buffer;
determining whether an area is selected for the target image; and
processing the target images such that the corresponding selected area of the target image stored in the first image buffer is displayed for the selected area, and the corresponding unselected area of the converted image stored in the second image buffer is displayed for the unselected area, when it is determined that the specific area is selected.

12. The area selection processing method of claim 11, wherein the converting of the target image comprises image filtering of the target image.

13. The area selection processing method of claim 12, wherein the image filtering comprises any one selected from Blur, Embossing, Jitter, Sepia, Gray scale, and Invert.

14. The area selection processing method of claim 11, wherein the processing of the target images comprises:
superposing the target image stored in the first image buffer on the converted target image stored in the second image buffer; and
when it is determined that the specific area is selected, removing the unselected area among the whole area of the target image such that the corresponding area of the converted target image is displayed in the unselected area.

15. The area selection processing method of claim 11, wherein the processing of the target images comprises:
superposing the converted target image stored in the second image buffer on the target image stored in the first image buffer; and
when it is determined that the specific area is selected, removing an area corresponding to the selected area among the whole area of the converted target image such that the corresponding area of the converted target image is displayed in the unselected area.

16. An image display processing method for displaying an insert image added to a target image, the image display processing method comprising:
temporarily storing the added insert image in a first image buffer;
converting the insert image through an image conversion method;
temporarily storing the insert image converted through the image convertor in a second image buffer;
determining whether at least one area of the insert image departs from the whole area of the target image according to a location change of the insert image; and
processing the insert images such that the corresponding area of the insert image stored in the first image buffer is displayed for an area included in the target image among the whole area of the insert image, and the corresponding area of the converted insert image stored in the second image buffer is displayed for an area departing from the target image among the whole area of the insert image, when it is determined that at least one area of the whole area of the insert image departs from an area of the original target image according to the determination result.

17. The image display processing method of claim 16, wherein the converting of the insert image comprises image filtering of the target image.

18. The image display processing method of claim 17, wherein the image filtering comprises any one selected from Blur, Embossing, Jitter, Sepia, Gray scale, and Invert.

19. The image display processing apparatus of claim 16, wherein the processing of the insert images comprises:
superposing the insert image stored in the first image buffer on the converted insert image stored in the second image buffer; and
when it is determined that at least one area of the whole area of the insert image departs from an area of the original target image, removing the corresponding area of the insert image for the area departing from the target image among the whole area of the insert image such that the corresponding area of the converted insert image is displayed in the departing area.

20. The image display processing apparatus of claim 16, wherein the processing of the insert images comprises:
superposing the converted insert image stored in the second image buffer on the insert image stored in the first image buffer; and
when it is determined that at least one area of the whole area of the insert image departs from an area of the original target image, removing the corresponding area of the converted insert image for the area included in the target image among the whole area of the converted insert image such that the corresponding area of the converted insert image is displayed in the departing area.

21. A computer readable recording medium in which a program for executing the method of claim 11 is recorded.
